(19) United States
(12) Patent Application Publication
(10) Pub. No.: US 2001/0039902 A1
(43) Pub. Date: Nov. 15, 2001

(54) Materials composed of glass and flyash and methods of making the same

(76) Inventors: Charles W. Hedley, Three Forks, MT (US); Todd C. Quigley, Pasadena, CA (US); William J. Ritter, Bozeman, MT (US)

Correspondence Address: SHERIDAN ROSS P.C., Suite 1200, 1560 Broadway, Denver, CO, 80202-5141, US

(21) Appl. No.: 09/730,047

(22) Filed: Dec. 4, 2000

Related U.S. Application Data
(60) Provisional application No. 60/184,276, filed on Feb. 23, 2000.

(51) Int. Cl. C04B 18/06

(52) U.S. Cl. 106/705; 106/745

(57) ABSTRACT

The present invention discloses a concrete-like composition made from class C flyash and glass. The composition may also include an inhibitor, such as sodium borate, to control the time required for the composition to harden. A method for making the composition is also disclosed. The present invention further discloses a glass crushing apparatus which may be used to crush the glass used in the composition and method.

### CROSS-REFERENCE TO RELATED APPLICATIONS

This application claims priority of U.S. Provisional Patent Application Ser. No. 60/184,276, filed Feb. 23, 2000, which is incorporated herein by reference in its entirety.

### FIELD OF THE INVENTION

This invention relates to concrete-like materials made from glass and flyash, and to methods and apparatus for making the materials.

### BACKGROUND OF THE INVENTION

Portland cement based concrete is a composite material composed of specially selected natural aggregate (sand and/or gravel) and a binder (matrix) made of portland cement and water. The addition of water to the portland cement begins a complex hydration reaction that causes the cement to harden, thereby firmly fixing the aggregate in place.

The cost of transporting natural aggregate from mining locations to concrete-making plants can be expensive depending on the locations of the plants. Therefore, substituting natural aggregate with recycled materials, such as glass, would be desirable. Since only a small fraction of postconsumer glass is reused by the bottling and container industry, the supply of recycled glass is plentiful.

However, substituting recycled glass for natural aggregate and combining the glass with portland cement presents problems. The main problem is the chemical reaction that results from combining alkali in the cement paste and the silica in the glass, which is referred to as the alkali-silica reaction (ASR) in Meyer & Xi, “Use of Recycled Glass and Fly Ash for Precast Concrete,” J. of Materials in Civil Engineering, pp. 89-90 (May, 1999). In the Meyer & Xi study, recycled glass was explored to replace at least a portion of natural aggregate in making concrete. The researchers developed two new materials primarily made from recycled glass and flyash, which they referred to as “glascrete” and “ashcrete.” Glascrete is the replacement of recycled waste glass for the sand and/or gravel as the aggregate, with portland cement as the binder. However, the ASR caused by the alkali in portland cement and silica in the waste glass produced undesirable expansion of the resulting material. In an effort to alleviate ASR expansion, the researchers developed ashcrete, which contains chemically-activated Class-F flyash as a substitute for portland cement. The chemicals used in activating the Class-F flyash included sodium hydroxide and sodium silicate. The researchers found that the molar ratio of these chemicals had a critical effect on the strength of the resulting concrete-like material.

As noted above, recycled glass is plentiful. Similarly, about 50-60 million tons of flyash are generated per year of which about 10% is consumed by the cement and concrete industry. Overall, only about 27% of the flyash produced by the combustion of coal is currently reused or recycled, while the remainder is disposed in landfills. Accordingly, the supply of flyash is also plentiful. Thus, a need exists for methods of making concrete-like materials that can be made from recycled or waste products that do not require the use of harsh chemicals or other hazardous materials. The present invention satisfies this need and provides related advantages as well.

### SUMMARY OF THE INVENTION

The present invention is for a concrete-like composition made from class C flyash and glass. In one embodiment of the present invention, the glass of the composition is crushed glass. The crushed glass may have a size of about 8 mm or less. The concrete-like composition of the present invention may also include an inhibitor to control the time required for the composition to set. One possible inhibitor is sodium borate. The concrete-like composition may include sodium borate, as an inhibitor, in an amount ranging from about 0.1% to about 1.5% by weight of the class C flyash.

A further embodiment of the present invention is a method for making a concrete-like composition made from class C flyash and glass. Water and crushed glass are combined to form a slurry. Class C flyash is then added to the slurry. The class C flyash and the slurry are mixed to form a uniform mixture. The uniform mixture is then allowed to harden to form the concrete-like material.

In this method, the concrete-like composition may also include an inhibitor. This embodiment of the method further includes adding the inhibitor to the water and crushed glass of the first step described above. The inhibitor added in this step may be sodium borate. The water to class C flyash mass-based ration of this method may be in the range of about 0.17:1 to about 0.4:1. The crushed glass to class C flyash mass-based ratio of this method may be in the range of about 0:1 to about 1.4:1. Further, the amount of inhibitor, if added, may be in the range from about 0.1% to about 1.5% by weight of the class C flyash.

Another embodiment of this method may include the addition of reinforcing bar, anchor or wire mesh prior to allowing the uniform mixture to harden.

In yet another embodiment of the method, an additional step of exposing glass on the surface of the concrete-like material may be performed. The glass may be exposed in this embodiment by mechanical or chemical means. The mechanical means used to expose the glass may include sanding, sand blasting, grinding, or bush hammering. The chemical means used to expose the glass may include acid etching or in-mold treatments of the composition by water insoluble material. This water insoluble material may include vegetable oil, motor oil or WD-40®.

A glass crushing apparatus is also disclosed in the present invention. In one embodiment, the glass crushing apparatus includes a vessel and a glass crushing element. The glass crushing element includes a rotor shaft, a rotor driving element, and a flexible element. The rotor shaft extends into the vessel from the top and is attached to the rotor driving element at one end of the shaft. The flexible element is attached to the opposite end of the shaft, near the bottom of the vessel. The flexible element may be constructed of linked elements, such as a chain. In one embodiment of the present invention, the flexible element extends to approximately 95 percent of the vessel diameter. In another embodiment, steel pieces may be attached to opposite ends of the flexible element. The vessel may include a screen at the bottom of the vessel for sizing and removing glass crushed to the desired size.

### BRIEF DESCRIPTION OF THE DRAWINGS

FIG. 1 is diagram of an apparatus for crushing glass used in making the concrete-like materials of the present invention; and

FIG. 2 is a perspective view of one embodiment of the flexible element of the glass crusher of the present invention; and

FIG. 3 is a elevation view of one embodiment of connecting the flexible element to the shaft of the apparatus for crushing glass of the present invention.

### DETAILED DESCRIPTION OF THE INVENTION

The present invention generally relates to concrete-like materials comprised of an aggregate and a binder. More particularly, the invention provides materials made primarily of Class C flyash as the sole binder and crushed glass as the aggregate.

Flyash is a fine powder residue made of mineral matter generated from the combustion of pulverized coal and is generally classified as Class C or F. Class C flyash has pozzolanic properties and contains a high level of lime (CaO) which enables it to undergo a hydration reaction and harden in the presence of water. Class F flyash also has pozzolanic properties similar to Class C flyash, but little cementious properties without activation chemicals. Class C flyash is normally produced as a waste product from the combustion of lignite or subbituminous coal. According to ASTM Standards, Class C flyash must have a minimum of 50% SiO₂+Al₂O₃+Fe₂O₃, a maximum of 5% SO₃, a maximum moisture content of 3%, a maximum of 6% loss on ignition, a maximum of 34% retained on a #325 screen, a minimum 75% of control strength at seven and twenty eight day strengths, and a maximum of 0.8% expansion. Furthermore, some Class C flyash can have lime contents above 10%. The flyash used in Example 1 below was obtained from the Corette Power Plant in Billings, Montana or from the Council Bluffs Power Plant in Council Bluffs, Iowa. The coal used in the Corette Power Plant comes from the Eagle Butte mine in the Powder River Basin in Wyoming. The coal used in the Council Bluffs Power Plant also comes from the Powder River Basin in Wyoming, but from a different mine. Class C flyash usually results from burning lignite or sub-bituminous coal. In theory, any plant burning these coals could produce Class C flyash. However, not all Class C flyashes perform as well as the flyash produced at the Corette plant.

Although not required for all applications, the concrete-like materials preferably contains an aggregate and Class C flyash as the binder. Materials having the greatest strength only contain a mixture of flyash and water. However, it is difficult, but not impossible, to mix flyash and water to a uniform consistency. Therefore, an aggregate is useful for mixing flyash and water to obtain a more uniform consistency even though the strength of the resulting material is reduced compared to flyash and water alone. The addition of the aggregate, however, has beneficial effects as described in more detail below.

The aggregate used in the materials of the present invention is glass, which can be obtained from any source, including, for example, recycled glass. The glass is first crushed to a desired size, preferably ranging from 425 μm (number 40 screen) to about 8 mm. Generally, smaller size pieces produce concrete-like materials having greater strength. Although pieces smaller than ¼″ are preferable, and more preferably less than ⅛″, glass pieces larger than ¼″ can be used for applications not requiring as much strength obtained when using smaller pieces. Any method known to those skilled in the art can be used to crush glass to the desired size.

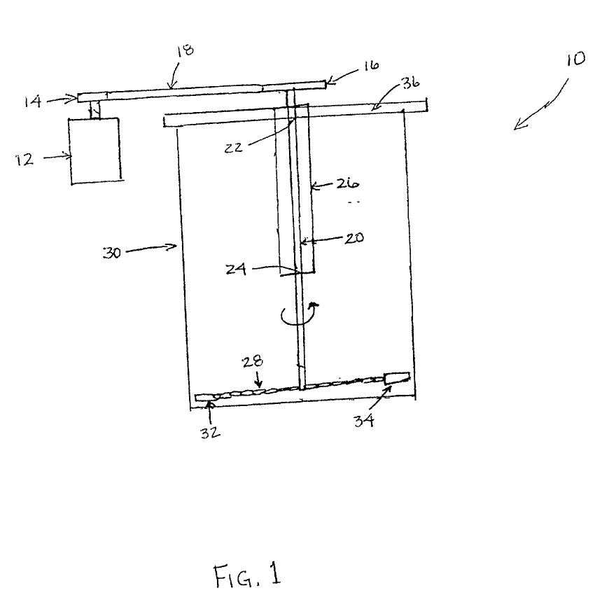

The crushing machine 10 shown in FIG. 1 is particularly useful for crushing glass to the desired size. In this embodiment, the machine 10 is driven by a motor 12, which is attached to a first pulley 14. The first pulley 14 is connected to a second pulley 16 by a belt 18. A rotating shaft 20 is attached to the second pulley 16. The shaft 20 passes through first and second bearings 22, 24, mounted centrally on the drum 30, which stabilize the shaft 20 during rotation. The bearings 22, 24 are mounted on a casing 26 enclosing a portion of the shaft 20. The shaft 20 is attached to a flexible element 28 near the bottom of the drum 30. The flexible element 28, as shown in FIG. 1, is constructed from linked elements, i.e., a chain. First and second steel pieces 32, 34 are attached to each end of the flexible element 28 as shown in FIG. 1. The steel pieces 32, 34 are preferable constructed of a hard grade steel. Although lower grade steel can be used, such pieces may need to be replaced more often than hard grade steel since glass is fairly abrasive. The steel pieces 32, 34 are close to the sides of the drum 30 without contacting it. The flexible element 28, and optional steel pieces 32, 34, preferably extend to at least 75% of the diameter of the drum 30, more preferably extend to at least 90% of the diameter of the drum 30, and most preferably extend to at least 95% of the diameter of the drum 30. Optionally, more than one flexible element and steel pieces can be attached to the shaft 20 to facilitate the crushing process.

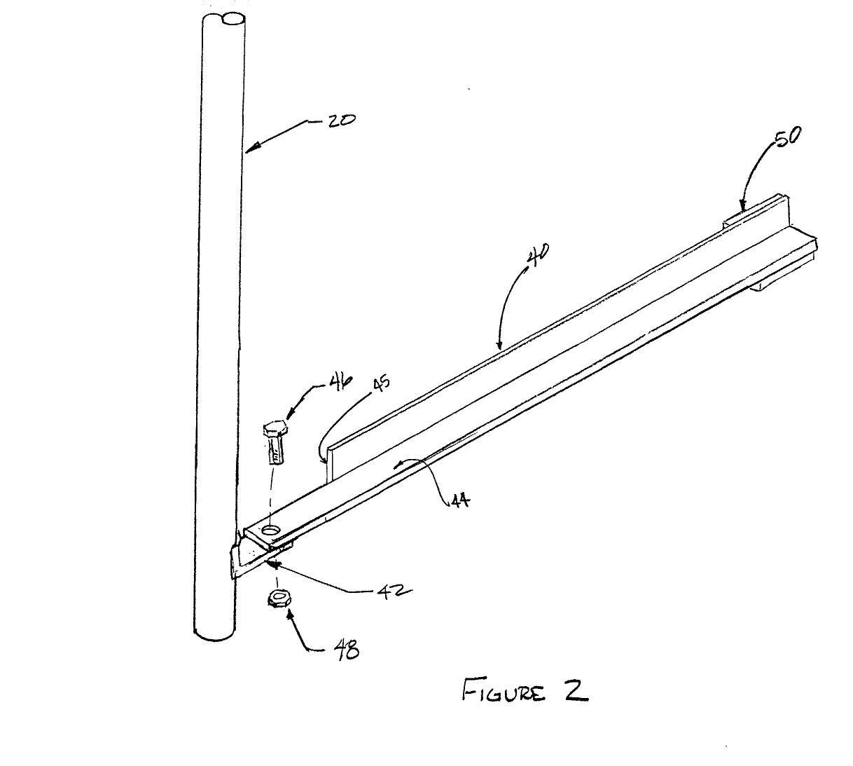

While the flexible element 28 of FIG. 1 is shown as linked elements, i.e., a chain, other embodiments of the flexible element 28 are possible. For example, the flexible element 28 may be constructed from a braided wire or cable. As shown in FIG. 2, the flexible element 28 may also be constructed as a hinged flail 40 or hammer. The flail 40 may be hingedly attached to the crushing machine shaft 20 at a shaft connection 42 with a shaft connection bolt 46 and a shaft connection bolt 48. The flail may rotate about the axis of the shaft connection bolt. The flail 40 may be constructed from angle shaped steel. In the embodiment of FIG. 2, the flail is constructed of angle steel with the bottom leg 44 of the angle parallel to the bottom of the drum 30 and the vertical leg 45 extending upward, parallel to the bottom of the drum 30. A portion of the vertical leg 45 maybe removed from the shaft end of the flail 40. Additionally, a reinforcement angle 50 may be attached to the outboard end of the flail 40 to extend the useful life of the flail 40 by increasing both the thickness and the mass of the flail 40. The reinforcement angle 50 may be welded to the flail 40 or may be removably attached, e.g., with a bolt and nut, to facilitate replacement of the reinforcement angle 50 when it becomes worn.

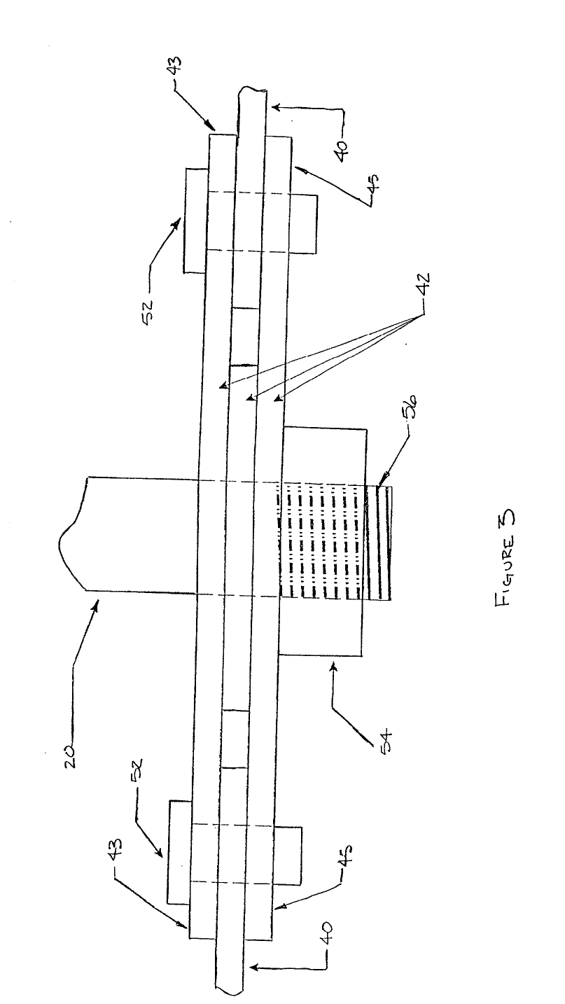

With reference to FIG. 3, the shaft connection 42 is attached to the shaft 20 and secured with a securement device 54. The securement device 54 in this embodiment is a tapped nut sized to be received onto threads 56 formed on the shaft 20. Also in this embodiment, the shaft connection includes an upper ear 43 and a lower ear 45 for attaching the flail 40. The portion of the flail 40 where the vertical leg has been removed is placed between the shaft connection upper ear 43 and lower ear 45. The flail 40 is then hingedly connected to the shaft connection 42 by a headed pin 52 inserted, respectively, through the upper ear 43, the flail 40, and the lower ear 45.

Glass, preferably recycled glass, is added to the drum 30 by lifting the upper lid 36. The motor 10 is then turned on to rotate the shaft 20, which in turn rotates the chain 28 and attached steel pieces 32, 34, thus crushing the glass. The crushed glass is then filtered through a screen having a desired mesh size and used in the methods of the present invention to produce the concrete-like materials. The screen may be mounted in the bottom of the drum 30 such that the glass may be continuously fed through the drum.

In an alternative embodiment, not shown in the drawings, the crushing machine 10 may include a hinged door and hopper in the side of the drum 30 for adding glass to the crushing machine 10. The door is hingedly attached to the hopper along the upper surface of the door and opens by swinging into the drum. The hopper is a chute, with a bottom and opposing sides, attached to the exterior surface of the drum adjacent to the door. The bottom and sides of the hopper slope toward the door to facilitate the addition of materials, such as glass, to the crushing machine 10.

The concrete-like materials of the present invention can optionally contain hydrated sodium borate, such as Na₂B₄O₇.10H₂O or Na₂B₄O₇.5H₂O. Additionally, sucrose, i.e., common table sugar, effectively retards the setting time of the composition. It is anticipated that other commercially available sugar-based retarders would also work effectively. Other surface retardants, for example, Rugasol-S®, may be used to create a desired surface appearance such as a rough finish created by the exposure the aggregate of the concrete-like material. The hydrated sodium borate is used to inhibit (i.e. slow down) the hydration reaction of the flyash that takes place in less than five minutes without the inhibitor. Filling a mold of any size is nearly impractical without the use of hydrated sodium borate. Thus, the use of the inhibitor extends the curing time of the flyash and allows more time for any desired manipulation of the mixture prior to hardening (for example, filling a mold). A desired curing time can be obtained by adjusting the amount of the inhibitor added to the mixture. The desired curing time can be extended at least about 0.5 hours, preferably at least about 1 hour, more preferably at least about 2 hours, even more preferably at least about 3 hours, and most preferably at least about 4 hours. For example, hydrated sodium borate can be added at 0.1% of flyash weight to extend the curing time for approximately fifteen minutes, while adding the inhibitor at 1.5% of flyash weight can increase the curing time to in excess of about 10 hours. The amount of sodium borate inhibitor by weight, if added, present in the mixture is about 0.1% of flyash weight, preferably about 0.50% of flyash weight, more preferably about 0.75% of flyash weight, even more preferably about 1.0% flyash weight, even more preferably about 1.25% flyash weight, and most preferably about 1.5% flyash weight.

The following mass-based ratios of the primary constituents (flyash, glass, water and hydrated sodium borate referred to as “inhibitor”) are particularly useful for producing the concrete-like materials of the present invention:

| | | |
|---|---|---|
| (i) | water:flyash | (0.17:1 to 0.4:1) |
| (ii) | glass:flyash | (0.1:1 to 1.4:1) |
| (iii) | inhibitor | (0-1.5% of flyash weight) |

Concrete-like materials having varying strengths can be produced by altering these ratios. For example, compressive strengths ranging from 2,000 to 8,000 psi were obtained by varying the constituent ratios. Modulus of rupture ranging from 324 psi to 580 psi were also obtained. Standard ASTM tests were used for these measurements. Those skilled in the art can readily determine appropriate ratios for obtaining a desired strength without undue experimentation.

The present invention further provides methods of making the novel concrete-like materials. The methods are generally accomplished by:

(a) combining water and, optionally the crushed glass and inhibitor, in a mixer to form a slurry;

(b) sifting Class C flyash into the slurry; and

(c) mixing the Class C flyash and slurry to form a uniform mixture.

Any mixer can be used that provides sufficient agitation or rotation to mix the constituents. The size of the mixer will depend, in part, on the amount of desired material. A portable concrete mixer is useful for preparing a mixture that can be poured into molds.

In the methods, all constituents must be accurately weighed since very small variances in the weights of the constituents make large differences in the mixing properties. The desired amount of glass, water and inhibitor are first combined in a mixer to form a uniform slurry. The glass, water and inhibitor can be added to the mixer in any order or simultaneously. At high glass loadings, the glass has a tendency to form a very dense mass which the water cannot penetrate. Therefore, any dense mass must be broken up to obtain a uniform slurry before adding the flyash. Any method for breaking up the dense masses can be used, for example, a scraper with a long handle to manually break up the pieces. In certain situations it may be desirable to add a mixture of the pre-measured components to water and mix the composition to a uniform consistency. This pre-mixture of dry components may help to overcome difficulty of mixing water with dense masses of glass or other constituents.

The flyash is then sifted into the mixer through a screen or other sifting device that allows a reasonable flow of flyash into the mixture. If the flyash is added all at once or otherwise added too quickly, loosely held clods form which, if the surface of the clods become wet, form more durable clods that may not be broken up in the mixer. These durable clods can then lead to hot spots developing in the mixture that result in weak spots in the final product. Thus, adding the flyash at a reasonable flow prevents the formation of these durable clods. Those skilled in the art can readily determine an appropriate screen size that will substantially prevent the formation of durable clods. The flyash is mixed with the slurry until a uniform mixture is obtained.

It is also possible to pre-blend the dry ingredients (flyash, glass, and, if desired, inhibitor) prior to adding the mixture to water. In this method, blending should be monitored to ensure proper mixing of the pre-blended dry ingredients with the water. It should be noted that the water may be added to the mixture, rather than adding the mixture to water.

If desired, the resulting mixture can be poured into any desired mold until cured. The mold can be made of any material useful for molding concrete, including, for example, wood, plastic, fiberglass, steel, brass or any combination thereof such as wood and plastic. All release well from the final hardened material.

Reinforcing bars and mesh can be embedded, as well as lifting and fastening anchors, in the material prior to hardening. An anchor can also be attached in the hardened material with wedge lock fasteners. The reinforcing bars and mesh increases the tension strength of the resulting material. Other methods of increasing the strength of concrete can also be used to strengthen the final product of the present invention. For example, steel or glass fibers may be added to the slurry prior to curing to increase the strength of the cementitious material.

The concrete-like materials of the present invention can be used for any structural or decorative application. In particular, the materials can be used in structural applications for which portland cement-based concrete is used, including load-bearing applications.

The finished pieces can have a smooth paste surface or, through the use of mechanical or chemical means, the glass can be exposed yielding a surface that is both decorative and durable. Sanding, sand blasting, grinding, and acid etching can all be used to expose the glass. Alternatively, in-mold treatments that weaken the surface of the cured piece allowing effortless removal of the paste and thus exposure of the glass can also be used. Water insoluble materials, such as WD-40, vegetable oils, motor oil and the like, can be used in this regard.

In addition to the decorative qualities, there are beneficial reasons to expose the glass. Glass is hard and inert and provides a durable wear surface. The processed glass for this material contains no sharp edges so there is no danger of being cut by coming into contact with the finished product. Also, by removing the paste down below the surface of the glass, a textured surface is created which offers improved traction, which is desirable when used as flooring. Furthermore, the use of different sizes and colors of glass can create striking aesthetic effects when exposed.

The composition of the present invention has myriad uses. For example, the composition can be used to form pre-cast articles such as tiles, wall panels, benches, counter tops, pavers, architectural details, and planters. The composition may also be used in structural applications such as supporting structural steel beams or in poured foundations for houses. The composition may also be used in non-traditional applications including kitchen, laboratory or other counter tops, desk tops, sinks, bath tubs, and floor tiles. While not all applications are appropriate, essentially any shape that can be cast in portland concrete may be cast with the cementitious material of the present invention.

The composition may also be used in mine shafts to fill an existing shaft so that another shaft may be created near the existing shaft. During mining operations in a hard rock mine, ore is crushed into a fine powder, or “tailings,” to remove the metals. The tailings are typically stockpiled near the mine and are considered a nuisance. In a process called “pasting,” the tailings are combined with a cementitious material and pumped back into the mine shafts to harden, essentially “pasting” them back together. Miners may then tunnel either under or over the “pasted tailings” as they extract more ore. This allows a more complete extraction of mineral values since subsequent tunnels may be cut right next to the pasted tailings.

The composition also has application in grouting well casings used in methane wells. In this application, a cementitious slurry is pumped down the inside of the well casing. Once the slurry reaches the bottom of the well casing, the slurry begins to flow up the outside of the casing until it reaches the surface. Once the material hardens, the casing is locked in place and the material inside the well casing is drilled out. Optimally, the cementitious material has some expansive properties, or is at least non-shrinking, in order to secure the casing to the surrounding formation.

Another alternative application for the composition, i.e., using the composition to make counter tops, is one embodiment of the present invention. In this application, a sheet of low density foam is laminated on both sides with fiber reinforced plastic (fiberglass and any suitable polymeric resin) producing a stiff yet lightweight sheet. The sheet, or “core,” can be cut to the desired shape or have any special details cut in it, e.g., a cutout for a sink. Forms are then placed around the from board such that there is a gap of approximately one inch between the form and the edge of the core. This allows the core's edge to be covered by the cementitious material. The forms should extend above the core to the desired thickness of the counter top with at least about one-quarter inch of material covering the top of the core. For certain applications, the strength requirements of the counter top may require that the material thickness covering the top of the core be at least one-half inch. The top and sides of the core that will be in contact with the cementitious material are preferably coated with a preparation that will provide a bond between these materials, such as concrete glue. The cementitious material can then be cast over the core and finished using standard concrete finishing methods. Integral colors, stains, stamping, and methods fo exposing the aggregate are all acceptable means of finishing. The core will replace an equivalent volume of the cementitious material thereby reducing the overall mass of the counter top. This has the effect of reducing the overall mass of the counter top. This, in turn, has the effect of reducing the weight on the supporting structure of the counter top, such as cabinetry. In addition, larger pieces could be made which would still be manageable by installers.

The following experimental results are provided for the purposes of illustration only and are not intended to limit the scope of the invention.

### EXAMPLE

Table 1 below shows various compositions of the present invention including the amounts of each component and the compression strength of the composition after a stated curing time. Each horizontal row indicates the parameters used for an individual test of the composition. The first vertical column identifies the individual test by number. Columns 2-4 indicate the percentage, by weight, of each primary ingredient, Class C flyash, glass, and water. The Class C flyash used in the tests was produced by the Corrette Power Plant or is a mixture of Class C flyash produced by both the Corrette Power Plant and the Council Bluffs Power Plant. Column 5 indicates the amount of borax, as a weight percentage of Class C flyash, added to the composition. The sixth and seventh columns show the approximate ratio by weight of glass and water, respectively, to flyash based on the percentages listed in columns 2-4. The eighth column shows the strength of the composition of the respective mixture. The strength listed in column 8 lists the compressive strength of a representative, individual two inch cube sample tested by the method described below. The ninth column shows the curing time of the composition prior to being subjected to strength testing.

The components, in the weight percentages listed in columns 2-5, were mixed together to form the composition. In some test compositions, the dry ingredients were blended together prior to being added to water. In other test compositions, the dry ingredients were added to water and then mixed.

The compression strength of the composition was measured by forming the composition into specimens as both 2 inch cubes and 4″×8″ cylinders. The specimens were then placed into a compression testing machine, which included a pair of horizontally parallel platens capable of being brought together with great force, e.g., 200,000 pounds. The platens were brought together until the specimen failed. The machine recorded the load at the time of failure.

The composition was also tested for modulus of rupture, i.e. tensile strength. In this test, 6″×6″×20″ beams were used as specimens. The same compression testing machine was used, however, the load was applied in a four point bending arrangement. As in the compression strength test, the machine recorded the load at the time of failure of the specimen. The modulus of rupture test results were used primarily to establish a correlation between the compressive strength and the tensile strength of the composition of the present invention similar to that of portland cement compositions. The modulus of rupture test results are not listed in Table 1.

TABLE 1

| | | | | | | | Strength | |
|---|---|---|---|---|---|---|---|---|
| Test | % Ash | % Glass | % Water | % Borax | Glass/Ash | Water/Ash | (psi) | Days |
| 1 | 68 | 17 | 15 | 0.38 | 0.25 | 0.22 | 659 | 0.08 |
| 2 | 45 | 44 | 11 | 0.25 | 1 | 0.25 | 1306 | 18 |
| 3 | 45 | 44 | 11 | 0.35 | 1 | 0.25 | 4602 | 28 |
| 4 | 29 | 61 | 10 | 0.4 | 2.1 | 0.34 | 2175 | 27 |
| 5 | 29 | 63 | 8 | 0.4 | 2.2 | 0.28 | 1288 | 14 |
| 6 | 45 | 44 | 11 | 0.31 | 1 | 0.25 | 3084 | 7 |
| 7 | 37 | 52 | 11 | 0.25 | 1.4 | 0.29 | 3351 | 15 |
| 8 | 39 | 51 | 10 | 0.4 | 1.3 | 0.27 | 4941 | 13 |
| 9 | 42 | 48 | 10 | 0.42 | 1.1 | 0.24 | 5580 | 87 |
| 10 | 44 | 44 | 12 | 0 | 1 | 0.27 | 703 | 6 |
| 11 | 45 | 44 | 11 | 0 | 1 | 0.25 | 3991 | 28 |
| 12 | 45 | 44 | 11 | 0.25 | 1 | 0.25 | 92.5 | 0.25 |
| 13 | 45 | 44 | 11 | 0.31 | 1 | 0.25 | 4326 | 14 |
| 14 | 45 | 44 | 11 | 0 | 1 | 0.25 | 1985 | 28 |
| 15 | 50 | 38 | 12 | 0.4 | 0.75 | 0.25 | 4124 | 15 |
| 16 | 55 | 28 | 17 | 0.4 | 0.5 | 0.31 | 5335 | 28 |
| 17 | 58 | 28 | 14 | 0.4 | 0.5 | 0.24 | 4542 | 22 |
| 18 | 56 | 28 | 16 | 0.4 | 0.5 | 0.29 | 4715 | 14 |
| 19 | 57 | 29 | 14 | 0.4 | 0.5 | 0.25 | 5094 | 19 |
| 20 | 58 | 29 | 13 | 0.4 | 0.5 | 0.22 | 5125 | 14 |
| 21 | 58 | 29 | 13 | 0.35 | 0.5 | 0.22 | 6771 | 29 |
| 22 | 57 | 29 | 14 | 0.35 | 0.5 | 0.24 | 4278 | 28 |
| 23 | 63 | 23 | 14 | 0.34 | 0.37 | 0.22 | 4840 | 25 |
| 24 | 62 | 22 | 16 | 0.35 | 0.35 | 0.26 | 4904 | 21 |
| 25 | 63 | 23 | 14 | 0.35 | 0.36 | 0.22 | 5134 | 21 |
| 26 | 65 | 18 | 17 | 0.4 | 0.28 | 0.26 | 6205 | 18 |
| 27 | 65 | 18 | 17 | 0.4 | 0.28 | 0.26 | 8408 | 154 |
| 28 | 65 | 18 | 17 | 0.4 | 0.28 | 0.26 | 8083 | 52 |
| 29 | 65 | 19 | 16 | 0.4 | 0.29 | 0.25 | 6213 | 11 |
| 30 | 67 | 17 | 16 | 0.35 | 0.25 | 0.24 | 57 | 0.08 |
| 31 | 67 | 20 | 13 | 0.78 | 0.30 | 0.19 | 4587 | 19 |
| 32 | 68 | 17 | 15 | 0.3 | 0.25 | 0.22 | 2838 | 6 |
| 33 | 76 | 0 | 24 | 0 | 0 | 0.32 | 236 | 0.25 |
| 34 | 78 | 0 | 22 | 0 | 0 | 0.28 | 7425 | 93 |
| 35 | 80 | 0 | 20 | 0.3 | 0 | 0.25 | 6760 | 13 |
| 36 | 85 | 0 | 15 | 0.27 | 0 | 0.18 | 10787 | 14 |

While various embodiments of the present invention have been described in detail, it is apparent that modifications and adaptations of those embodiments will occur to those skilled in the art. However, it is to be expressly understood that such modifications and adaptations are within the spirit and scope of the present invention, as set forth in the following claims.

What is claimed is:

1. A concrete-like composition comprising class C flyash and glass.

2. The composition of claim 1, wherein the glass is crushed glass.

3. The composition of claim 2, wherein the crushed glass is in a size of about 8 mm or less.

4. The composition of claim 1, further comprising an inhibitor.

5. The composition of claim 4, wherein the inhibitor is sodium borate.

6. The composition of claim 5, wherein the inhibitor is present in the composition in an amount ranging from about 0.1% to about 1.5% by weight of the class C flyash.

7. The composition of claim 1, wherein the composition is in the form of an article selected from the group consisting of wall panels, tiles, benches, counter tops, pavers, planters, and architectural details.

8. The composition of claim 7, wherein the composition is in the form of a counter top.

9. The composition of claim 8, wherein the counter top further comprises a central core.

10. The composition of claim 9, wherein the central core comprises a low density foam laminated with fiber reinforced plastic.

11. The composition of claim 9, wherein the thickness of the composition surrounding the central core is at least about one-quarter inch.

12. A method for making a concrete-like material, comprising the steps of:
(a) combining water and crushed glass to form a slurry;
(b) adding class C flyash into the slurry;
(c) mixing the class C flyash and slurry to form a uniform mixture; and
(d) allowing the uniform mixture to harden to form the concrete-like material.

13. The method of claim 12, wherein an inhibitor is added in step (a).

14. The method of claim 13, wherein the inhibitor is sodium borate.

15. The method of claim 12, wherein a mass-based ratio of 0.17:1 to 0.4:1 (water:class C flyash) is used in the method.

16. The method of claim 12, wherein a mass-based ratio of 0:1 to 1.4:1 (crushed glass:class C flyash) is used in the method.

17. The method of claim 13, wherein the inhibitor is added to in step (a) in an amount from 0.1% to about 1.5% of class C flyash weight.

18. The method of claim 12, further comprising adding a reinforcing bar, anchor or mesh to the uniform mixture prior to step (d).

19. The method of claim 12, further comprising:
(e) exposing glass on the surface of the concrete-like material.

20. The method of claim 19, wherein the glass is exposed by mechanical or chemical means.

21. The method of claim 20, wherein said mechanical means is by sanding or sand blasting.

22. The method of claim 20, wherein said chemical means is by acid etching or in-mold treatments with water insoluble material.

23. The method of claim 22, wherein the water insoluble material is WD-40, motor oil or vegetable oil.

24. A method of making a concrete-like material, comprising the steps of:
(a) combining crushed glass and class C flyash to form a dry mix;
(b) mixing the dry mix with water to form a uniform mixture; and
(c) allowing the uniform mixture to harden to form the concrete-like material.

25. The method of claim 24, wherein an inhibitor is added in step (a).

26. The method of claim 25, wherein the inhibitor is sodium borate.

27. The method of claim 24, wherein a mass-based ratio of 0.17:1 to 0.4:1 (water:class C flyash) is used in the method.

28. The method of claim 24, wherein a mass-based ratio of 0:1 to 1.4:1 (crushed glass:class C flyash) is used in the method.

29. The method of claim 25, wherein the inhibitor is added to in step (a) in an amount from 0.1% to about 1.5% of class C flyash weight.

30. The method of claim 24, further comprising adding a reinforcing bar, anchor or mesh to the uniform mixture prior to step (c).

31. The method of claim 24, further comprising:
(d) exposing glass on the surface of the concrete-like material.

32. The method of claim 31, wherein the glass is exposed by mechanical or chemical means.

33. The method of claim 32, wherein said mechanical means is by sanding or sand blasting.

34. The method of claim 32, wherein said chemical means is by acid etching or in-mold treatments with water insoluble material.

35. The method of claim 34, wherein the water insoluble material is WD-40, motor oil or vegetable oil.

36. A glass crushing apparatus, comprising:
a vessel having a top, a bottom, and a diameter; and
a glass crushing element, comprising a rotor shaft having a first and second end, a rotor driving element, and a flexible element, wherein the rotor shaft is centrally located in said vessel and said first end of said rotor shaft extends from the top of said vessel, said rotor driving element is operatively engaged with said first end of said rotor shaft, and said flexible element is attached to said second end of said rotor shaft.

37. The glass crushing apparatus of claim 36, wherein the vessel further comprises a screen at said vessel bottom.

38. The glass crushing apparatus of claim 36, wherein said flexible element comprises linked elements.

39. The glass crushing apparatus of claim 38, wherein the flexible element extends to at least 95 percent of said vessel diameter.

40. The glass crushing apparatus of claim 38, wherein said glass crushing element further comprises steel pieces attached to opposite ends of said flexible element.
